(19) United States
(12) Patent Application Publication
(10) Pub. No.: US 2009/0251989 A1
(43) Pub. Date: Oct. 8, 2009

(54) Streamlined flow mixer

(76) Inventors: William C. Pfefferle, Madison, CT (US); Shahrokh Etemad, Trumbull, CT (US); Benjamin Baird, Rocky Hill, CT (US)

Correspondence Address: Robert L. Rispoli;Precision Combustion, Inc., 410 Sackett Point Road, North Haven, CT, 06473, US

(21) Appl. No.: 12/317,524

(22) Filed: Dec. 23, 2008

(30) Foreign Application Priority Data
Jun. 26, 2007 (US) PCT/US2007/014806

(51) Int. Cl. B01F 5/06

(52) U.S. Cl. 366/340

(57) ABSTRACT

A streamlined flow mixer is provided that includes a housing and a plurality of tubes having an upstream end and a downstream end. The tubes are flared at the downstream end. The mixer includes a header plate and the upstream end of each tube passes through the header plate in such as fashion as to be sealed therein. The housing may extend further downstream than the tubes and proved a mixing region. A second header plate may be added to provide for mixing more than two fluids.

### CROSS-REFERENCE

This application claims the benefit of U.S. Provisional Application No. 60/816,569 filed Jun. 26, 2006.

### FIELD OF THE INVENTION

The present invention is generally directed to an apparatus for providing rapid mixing of two or more reactants. In particular, the present invention is directed toward providing rapid mixing while eliminating regions of low velocity.

### BACKGROUND OF THE INVENTION

In the current state of the art, rapid mixing is often achieved by the use of impinging jets or solid projections into the flow which promotes mixing by development of large scale flow structures (through a static mixer or swirler arrangement). These flow structures can often lead to flame stabilization which is unacceptable in many applications. One such application is the mixing of oxygen and other reactants for introduction to a fuel cell. Fuel cell mixers are particularly difficult due to the high reaction rate of oxygen with the other reactants and in that, for overall system efficiency considerations, the reactants are often at high temperatures which further increases the reaction rate.

In many applications, there is a need to mix two or more reactants in such a way as to rapidly mix the components while eliminating regions of low velocity. Rapid mixing is necessary to reduce the time that the fluid remains in an intermediate state of mixing. Intermediate mixtures may have an increased reactivity compared to the completely mixed case or may react in such a way as to produce unwanted products. Regions of low velocity, either through stagnation of the flow in the wake of a structure inserted into the flow or through strong recirculations, are undesirable due to the possibility of stabilizing a flame or other region of unwanted rapid reaction.

### BRIEF DESCRIPTION OF THE DRAWINGS

FIG. 1 is a longitudinal cut away of a streamlined flow mixer according to the present invention.

FIG. 2 is a schematic representation of the discharge end of a streamlined flow mixer according to the present invention.

FIG. 3 is a longitudinal cut away of a streamlined flow mixer according to the present invention.

FIG. 4 depicts a profile cut away of two tubes of one embodiment of a streamlined flow mixer according to the present invention.

FIG. 5 provides a graphical depiction of the CFD results of a streamlined flow mixer according to the present invention.

### DESCRIPTION OF THE INVENTION

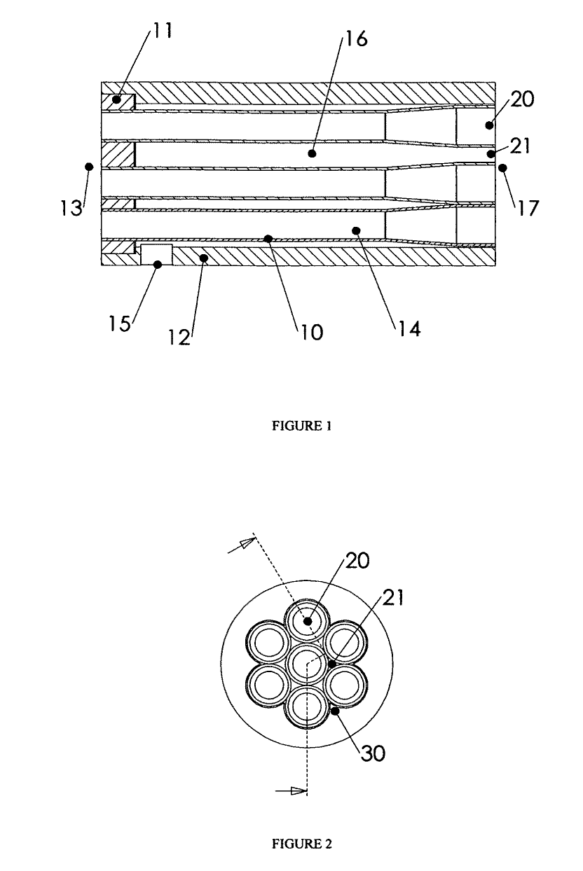

A streamlined flow mixer according to the present invention is depicted in FIG. 1. Two fluid streams 13 and 15 are mixed to produce mixed stream 17. The design incorporates a bed of tubes 10 which are flared on the downstream end. The bed is created such that the inlet of the tubes 10 is supported by passing though a specially manufactured plate 11 which is sealed around the tubes through brazing, welding, or other similar method. The flaring is used to separate the tubes and provide a chamber for introducing fluid 15 into the mixing device. Large flaring avoids a large pressure drop for stream 16 at the expense of slightly higher pressure drop across stream 14 by having lower number of tubes. The exit of the tubes 20 are supported by the tight packing of the surrounding flared tubes held in by an outer jacket or housing 12 which may or may not have a peripheral scalloping 30 as shown in FIG. 2.

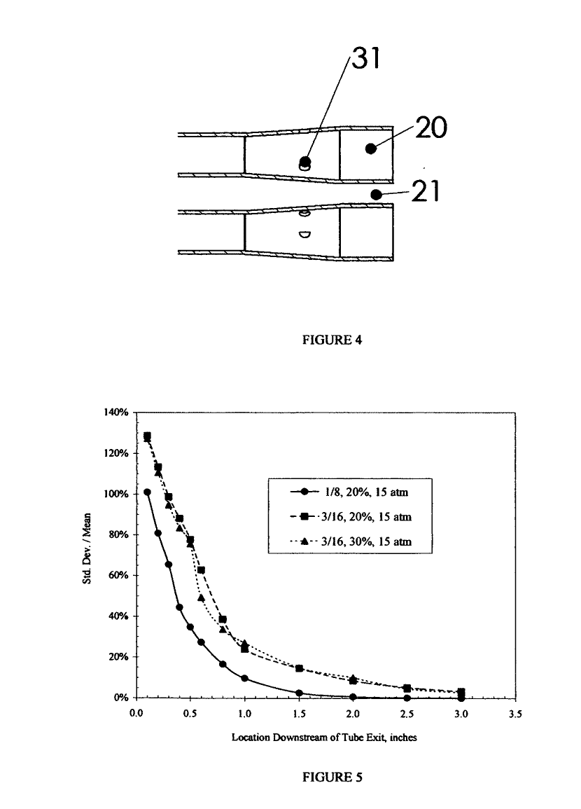

The current design produces rapid mixing through two mechanisms. One flow is distributed into the other flow through multiple injection points 21 within stream 20 as shown in FIG. 2. This maximizes the mixing of the fluids through diffusion. The second mechanism for rapid mixing comprises developing large differences in the exit velocities between streams 20 and 21 of the reactants creating a strong and vigorous shear layer. In another embodiment of the present invention, the first mechanism is further enhanced through multiple injection points 31 within tubes 10 as shown in FIG. 4.

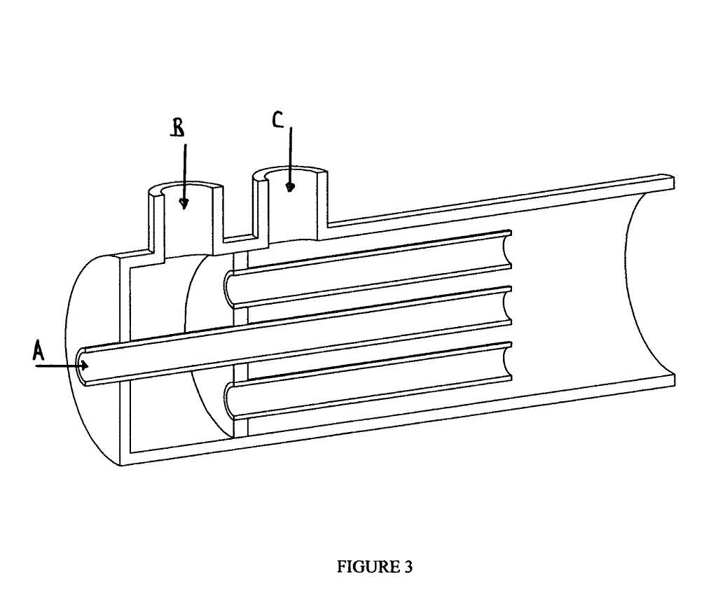

The present invention can also be used for mixing more than two fluids. FIG. 3 shows the geometry where three different fluids, Fluid A, Fluid B and Fluid C are mixed.

Variants of the design include, but are not limited to; (i) the geometric arrangement of the tubes in the bed such as, for example, that described in PCT/US2006/041257; (ii) variation of the geometry of the individual tubes (i.e. varying ratio of the flare, varying the diameters of the tubes, tube wall thickness, tube end geometry, etc.); (iii) extending the mixing by creating additional flow paths by alternating the supply to the interior tubes between two or more fluids, and inclusion of holes (item 31 in FIG. 4) and slots in the end of the tubes to modify the open areas of the flow paths.

CFD calculations have been conducted to demonstrate the mixing of two fluids at 15 atm. In this case, we are combining a mixture of CO₂ and air emitting through the gaps in the end of the tube bed with air passing through the inside diameter of the tubes. Both fluids are at a temperature of 400C. The exit flow data is presented based on unmixedness of the concentration of CO₂ (Root Mean Squared Deviation of equivalence ratio/Average equivalence ratio). FIG. 5 shows unmixedness versus the downstream length for different tube diameters and flare size. The data shows that by changing the flare size from 20% to 30%, there is no major effect on down stream mixing. However, by reducing the tube diameter there is enhancement in mixing, such that complete mixing can be achieved within a shorter distance.

Although the invention has been described in considerable detail with respect to arrangements for fluid partitioning, it will be apparent that the invention is capable of numerous modifications and variations, apparent to those skilled in the art, without departing from the spirit and scope of the invention.

What is claimed is:

1. A streamlined flow mixer comprising:
a) a plurality of tubes having an upstream end and a downstream end and wherein the tubes are fared at the downstream end;
b) a header plate wherein the upstream end of each tube sealingly passes through;
c) a housing; and
d) wherein the flared ends of the tubes form interstitial openings.

2. The streamlined flow mixer comprising of claim 1 further comprising a mixing region immediately downstream of the downstream end of the plurality of tubes.

3. The streamlined flow mixer comprising of claim 1 wherein at least one tube defines an aperture proximate to the downstream end of the tube.

4. The streamlined flow mixer comprising of claim 1 further comprising:
d) a second housing;
e) a second header plate; and
f) at least one tube wherein the upstream end of the tube sealingly passes through the second housing.
